(19) United States
(12) Patent Application Publication
(10) Pub. No.: US 2016/0202594 A1
(43) Pub. Date: Jul. 14, 2016

(54) BACKLIGHT UNIT AND DISPLAY APPARATUS INCLUDING THE SAME

(71) Applicant: ELECTRONICS AND TELECOMMUNICATIONS RESEARCH INSTITUTE, Daejeon (KR)

(72) Inventors: Hee Seung KIM, Gwangju (KR); Sun Goo LEE, Gwangju (KR); Sei Hyoung LEE, Gwangju (KR); Soo Yong JUNG, Gwangju (KR)

(73) Assignee: ELECTRONICS AND TELECOMMUNICATIONS RESEARCH INSTITUTE, Daejeon (KR)

(21) Appl. No.: 14/993,739

(22) Filed: Jan. 12, 2016

(30) Foreign Application Priority Data
Jan. 13, 2015 (KR) 10-2015-0006014

(51) Int. Cl. G02F 1/313; F21V 8/00; H04N 13/04; G02B 27/22

(52) U.S. Cl. CPC G02F 1/313; G02B 27/2264; G02B 6/0023; H04N 13/0418; H04N 13/0497; H04N 13/0486

(57) ABSTRACT

Provided is a display apparatus. The display apparatus includes a backlight unit configured to successively output backlight at multi output angles and a display module configured to successively output a 3D image corresponding to the backlight in multi output directions respectively corresponding to the multi output angles.

### CROSS-REFERENCE TO RELATED APPLICATIONS

This application claims priority under 35 U.S.C. §119 to Korean Patent Application No. 10-2015-0006014, filed on Jan. 13, 2015, the disclosure of which is incorporated herein by reference in its entirety.

### TECHNICAL FIELD

The present invention relates to a backlight unit and a display apparatus including the same, and more particularly, to a backlight unit and a display apparatus including the same, which display a three-dimensional (3D) image.

### BACKGROUND

3D image display apparatuses are apparatuses that show different two-dimensional (2D) images to a left eye and a right eye of a user, thereby providing a 3D image that enables the user to feel a sense of three dimensions.

The 3D image display apparatuses are classified into a glasses type and a glasses-free type. Hereinafter, prior art references relevant to 3D image display technology based on a glasses-free type will be briefly described.

A directional backlight with reduced crosstalk has been described in a prior art reference (U. S. Patent Publication No. 2011/0285927 A1). The prior art reference, as illustrated in FIGS. 1A and 1B, discloses 3D image display technology that uses an optical waveguide 120 on which two source lights 122 and 124 are incident and a redirecting film 118, for transferring backlight to specific regions LE and RE.

In the prior art reference, as illustrated in FIGS. 1 and 2, a region which enables a user to feel a sense of three dimensions is limited to a specific region. Therefore, there is a limitation where a user's two eyes are accurately located at the specific regions LE and RE, in order for the user to look at a 3D image having a sense of depth and a realistic sense.

Controlling light sources and a directional backlight have been described in another prior art reference (U. S. Patent Publication No. 2014/0009508 A1). The other prior art reference discloses technology that provides a 3D image by using total internal reflection based on an incident angle of light incident on glass or an acrylic plate having a thickness which is reduced to a certain degree.

In the other prior art reference, as illustrated in FIG. 2, when a light source array 31 is turned on, backlight is irradiated onto a first viewpoint position 26, and when another light source array 33 adjacent to the light source array 31 is turned on, the backlight is irradiated onto a second viewpoint position 44.

In the other prior art reference, since a region onto which the backlight is irradiated is fixed, a region which enables a user to view a 3D image is limited.

A method where image information is concentrated on a previously designed viewpoint is referred to as multi-viewpoint-based 3D image display technology.

In the multi-viewpoint-based 3D image display technology, a high-quality 3D image is reproduced at a specific viewpoint, but at viewpoints deviating from the specific viewpoint, the quality of a reproduced 3D image is rapidly reduced.

Therefore, integral imaging (InIm) display technology for reproducing 3D image information even at an arbitrary viewpoint has been developed.

The InIm display technology, as illustrated in FIG. 3, uses a lens array including a plurality of lenses. The lens array is very suitable for providing vertical-parallax image information and horizontal-parallax image information.

However, in the InIm display technology, a resolution of a reproduced 3D image is reduced in providing the vertical-parallax image information and the horizontal-parallax image information through the lens array.

Therefore, horizontal parallax only integral imaging (HPO InIm) display technology that provides only a horizontal parallax without providing a vertical parallax has been developed for increasing a resolution of a 3D image.

The HPO InIm display technology provides a 3D image having only a horizontal parallax by using a lenticular lens sheet including a line-shaped lens.

Since the InIm display technology and the HPO InIm display technology need a separate device such as the lens array or the lenticular lens sheet for providing a sense of three dimensions, the manufacturing cost increases inevitably.

Moreover, the lens array or the lenticular lens sheet disposed in front of a display panel has a difficulty of design because a subpixel size of the display panel should very precisely match a size of a lens configuring the lenticular lens sheet.

Moreover, conventional methods have a common limitation where a resolution of a 3D image is reduced in proportion to the number of viewpoints.

### SUMMARY

Accordingly, the present invention provides a backlight unit and a display apparatus including the same, which provide a 3D image from various positions.

In one general aspect, a backlight unit for outputting backlight, used to reproduce a three-dimensional (3D) image, includes: a light source module configured to output collimated light whose an incident angle is adjusted; and an optical waveguide including a side surface receiving the collimated light and a top outputting backlight corresponding to the collimated light, wherein the optical waveguide outputs, through a whole portion of the top, the backlight whose an output angle is adjusted according to the incident angle.

In another general aspect, a display apparatus for reproducing a three-dimensional (3D) image includes: a backlight unit configured to successively output backlight at multi output angles; and a display module configured to successively output a 3D image corresponding to the backlight in multi output directions respectively corresponding to the multi output angles.

Other features and aspects will be apparent from the following detailed description, the drawings, and the claims.

### BRIEF DESCRIPTION OF THE DRAWINGS

FIGS. 1A to 3 are diagrams for describing 3D image display technology using a prior art directional backlight unit.

FIG. 4A is a perspective view illustrating a schematic structure of a grating module applied to a backlight unit according to an embodiment of the present invention.

FIG. 4B is a cross-sectional view taken along line I-I′ of FIG. 4A.

FIGS. 5A to 5C are diagrams illustrating an example where an output direction of output light is adjusted according to an incident angle between two incident lights incident on an optical waveguide.

FIGS. 6A to 6C are diagrams illustrating an example where an output direction of output light is adjusted by adjusting a rotation angle of an optical waveguide in a state where an incident angle between two incident lights incident on an optical waveguide is fixed.

FIGS. 7A to 7C are diagrams illustrating an example where an output direction of output light is adjusted according to an incident angle between two incident lights incident on both side surfaces of an optical waveguide.

FIG. 8 is a diagram illustrating a whole configuration of a display apparatus displaying a 3D image according to an embodiment of the present invention.

FIG. 9A is a diagram schematically illustrating a method of controlling ray output from a display panel according to a conventional multi-viewpoint-based 3D image display method.

FIG. 9B is a diagram schematically illustrating a method of controlling ray output from a display panel according to a conventional HPO InIm 3D image display method.

FIG. 9C is a diagram schematically illustrating a method of controlling ray output from a display panel according to an HPO InIm 3D image display method to which the present invention is applied.

FIG. 10 is a diagram illustrating a whole configuration of a display apparatus displaying a 3D image according to another embodiment of the present invention.

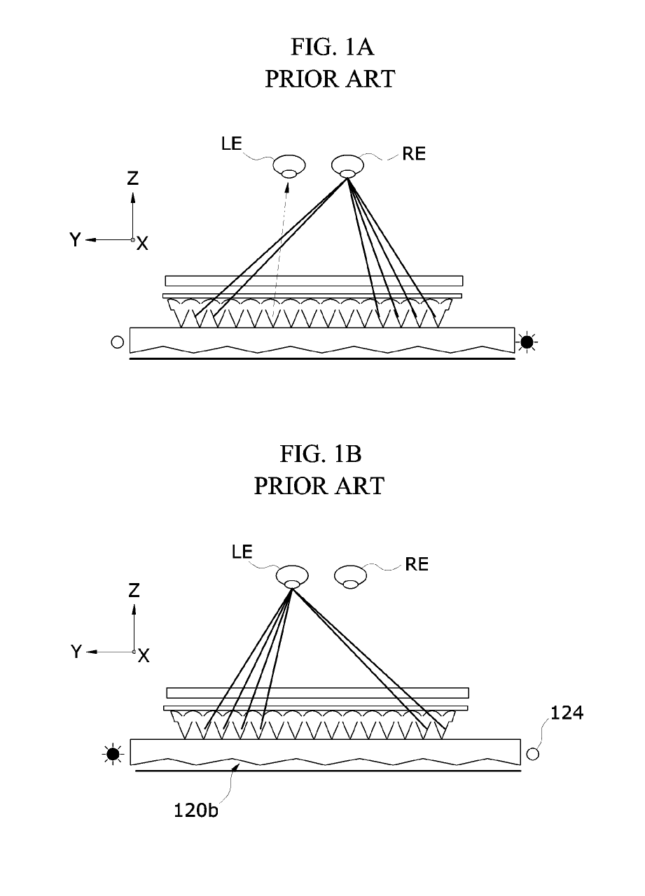

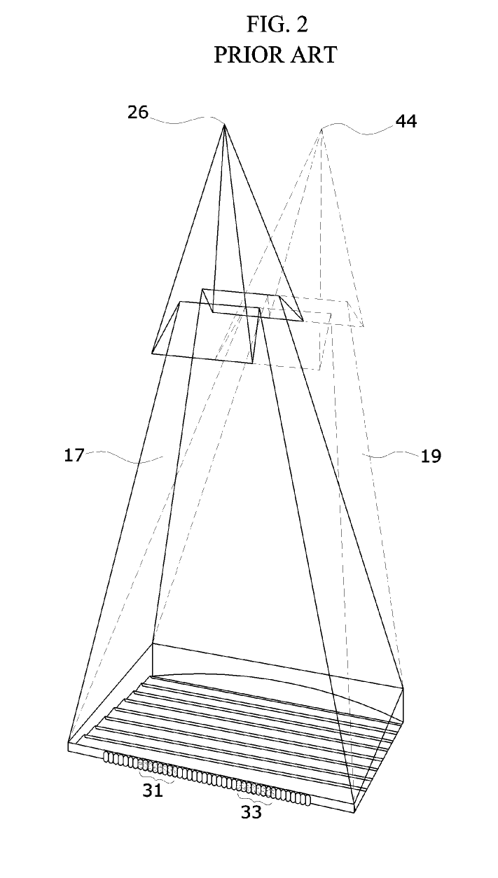

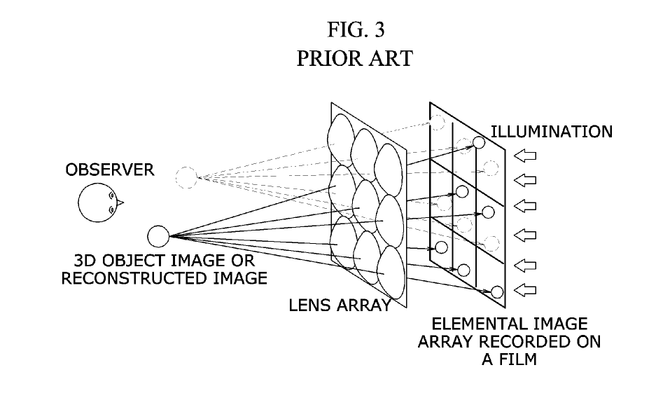

### DETAILED DESCRIPTION OF EMBODIMENTS

The present invention provides a directional backlight unit suitable for glasses-free stereoscopic display. The directional backlight unit according to an embodiment of the present invention includes a light source that emits collimated incident light and a flat optical waveguide that irradiates output light based on the incident light onto a display panel according to diffraction caused by a grating pattern, for providing a 3D image from various positions instead of a fixed position. As described above, the present invention provides a 3D image in an arbitrary direction instead of a fixed direction by using a directional backlight unit that is configured with a light source module and a flat optical waveguide without a separate device.

Moreover, the present invention time-divisionally controls all pixels of the display panel, and thus, the display panel provides output light, supplied from the grating module, as a 3D image capable of being viewed by a plurality of users at various positions without any reduction in resolution.

Hereinafter, embodiments of the present invention will be described in detail with reference to the accompanying drawings. The present invention may, however, be embodied in different forms and should not be construed as limited to the embodiments set forth herein. Like reference numerals refer to like elements throughout.

It will be understood that although the terms including an ordinary number such as first or second are used herein to describe various elements, these elements should not be limited by these terms. These terms are only used to distinguish one element from another element. For example, a first element may be referred to as a second element without departing from the spirit and scope of the present invention, and similarly, the second element may also be referred to as the first element. In the following description, the technical terms are used only for explain a specific exemplary embodiment while not limiting the present invention. The terms of a singular form may include plural forms unless referred to the contrary.

Terms used in the present invention have been selected as general terms which are widely used at present, in consideration of the functions of the present invention, but may be altered according to the intent of an operator of ordinary skill in the art, conventional practice, or introduction of new technology. Also, if there is a term which is arbitrarily selected by the applicant in a specific case, in which case a meaning of the term will be described in detail in a corresponding description portion of the present invention. Therefore, the terms should be defined on the basis of the entire content of this specification instead of a simple name of each of the terms.

In this disclosure below, when it is described that one comprises (or includes or has) some elements, it should be understood that it may comprise (or include or has) only those elements, or it may comprise (or include or have) other elements as well as those elements if there is no specific limitation. Moreover, each of terms such as “ . . . unit”, “ . . . apparatus” and “module” described in specification denotes an element for performing at least one function or operation, and may be implemented in hardware, software or the combination of hardware and software.

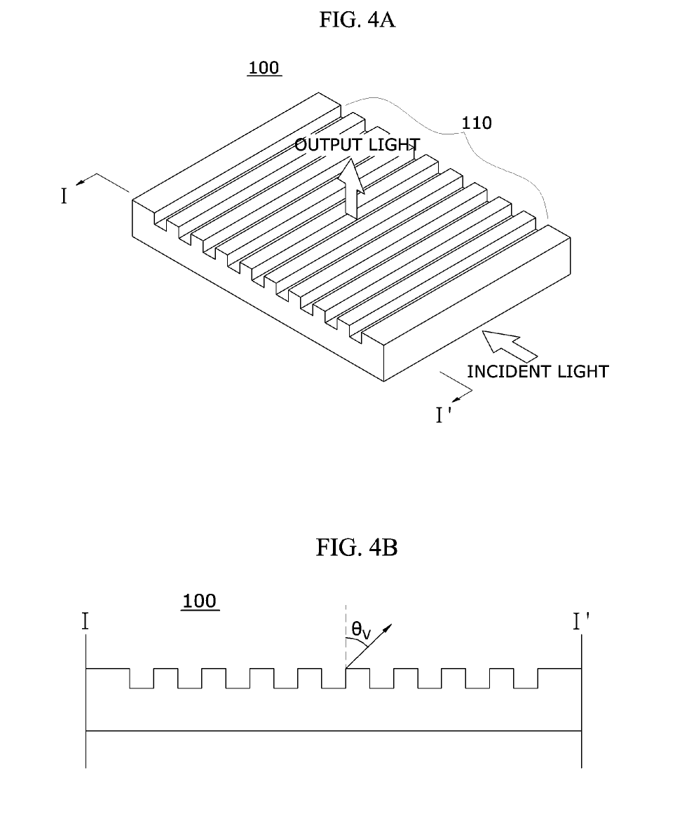

FIG. 4A is a perspective view illustrating a schematic structure of a grating module applied to a backlight unit according to an embodiment of the present invention. FIG. 4B is a cross-sectional view taken along line I-I′ of FIG. 4A.

Referring to FIGS. 4A and 4B, an optical waveguide 100 applied to the backlight unit according to an embodiment of the present invention may have a plate-shaped structure, and a plurality of grating patterns 110 may be periodically formed on a top of the optical waveguide 100.

Incident light which is incident through a side surface of the optical waveguide 100 may be diffracted by the grating patterns 110 and may be output as output light (or backlight) through a whole portion of the top. The grating patterns 110 may be provided as a plurality of projection patterns which extend in one direction at certain intervals.

An output angle “θᵥ” of the output light may be adjusted in order for the output light to be output in multi directions where a user is located, instead of a fixed direction.

The output angle “θᵥ” may be adjusted based on a wavelength of the incident light, a grating period of each of the grating patterns, a refractive index of the optical waveguide, and/or the like. Also, the output angle “θᵥ” may be adjusted an angle between an extension direction of the projection and an incident direction of the incident light. This may be understood as diffraction caused by the grating patterns.

The optical waveguide 100 applied to the backlight unit according to an embodiment of the present invention may receive the incident light in two directions from a light source, for transferring a left-eye image and a right-eye image corresponding to the user's two eyes.

The optical waveguide 100 may receive two incident lights corresponding to two independent light sources.

The optical waveguide 100 may receive two incident lights which are separated from single source light by a device, which changes a path of light, such as a polarization beam splitter, an optical switch, or the like.

The optical waveguide 100 may track a viewer's eyes by using eye tracking technology and then may adjust an incident angle between two incident lights to transfer the lights to a binocular position of the viewer.

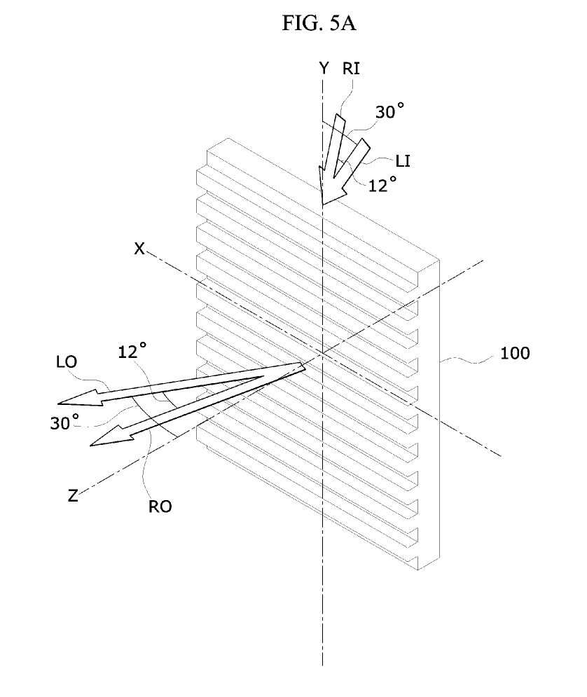

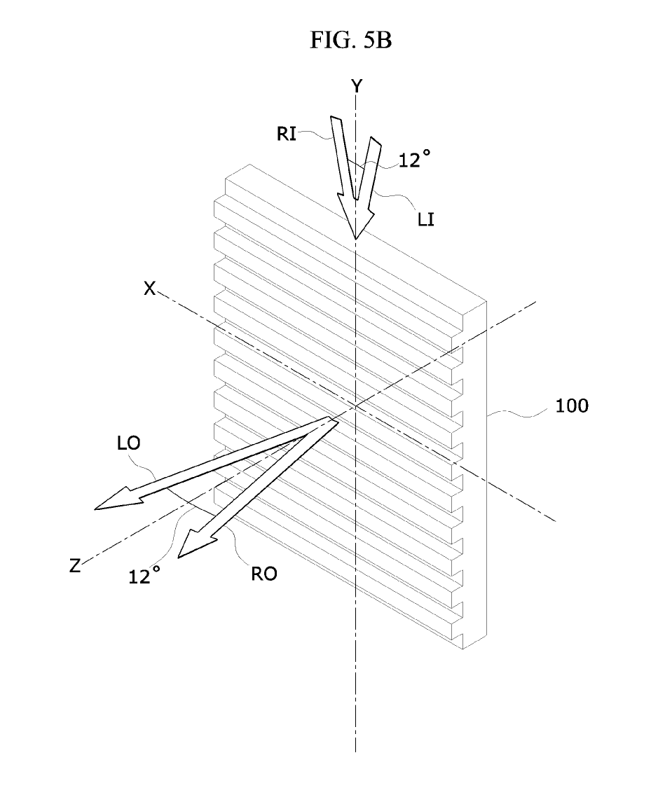

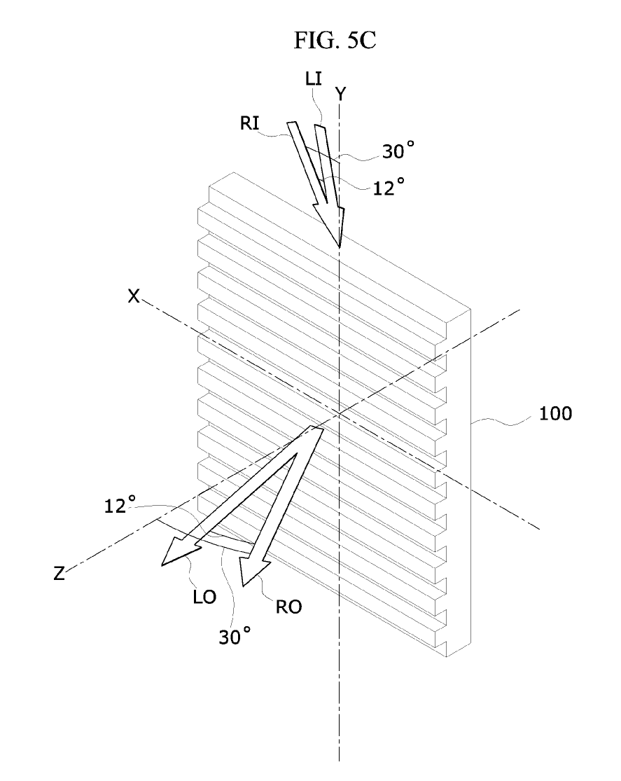

FIGS. 5A to 5C are diagrams illustrating an example where an output direction of output light is adjusted according to an incident angle between two incident lights incident on an optical waveguide.

To clearly describe output directions of two output lights corresponding to two input lights, it is assumed that a center of the optical waveguide 100 is an original point (0, 0, 0) of a three-dimensional (3D) coordinate system, and the optical waveguide 100 is disposed on a plane defined by the X axis and the Y axis.

As illustrated in FIG. 5A, when an incident angle between left-eye incident light L1 and right-eye incident light R1 is adjusted in a horizontal direction on a first quadrant defined by the X axis and the Y axis, left-eye output light L0 and right-eye output light R0 respectively corresponding to the left-eye incident light L1 and the right-eye incident light R1 may be adjusted in a horizontal direction on a second quadrant defined by the X axis and the Y axis.

As illustrated in FIG. 5B, when the left-eye incident light L1 is adjusted in the horizontal direction on the first quadrant defined by the X axis and the Y axis and the right-eye incident light R1 is adjusted in the horizontal direction on the second quadrant defined by the X axis and the Y axis, the left-eye output light L0 corresponding to the left-eye incident light L1 may be adjusted in the horizontal direction on the second quadrant defined by the X axis and the Y axis, and the right-eye output light R0 corresponding to the right-eye incident light R1 may be adjusted in the horizontal direction on the second quadrant defined by the X axis and the Y axis.

As illustrated in FIG. 5C, when an incident angle between the left-eye incident light L1 and the right-eye incident light R1 is adjusted in the horizontal direction on the second quadrant defined by the X axis and the Y axis, the left-eye output light L0 and the right-eye output light R0 respectively corresponding to the left-eye incident light L1 and the right-eye incident light R1 may be adjusted in the horizontal direction on the first quadrant defined by the X axis and the Y axis.

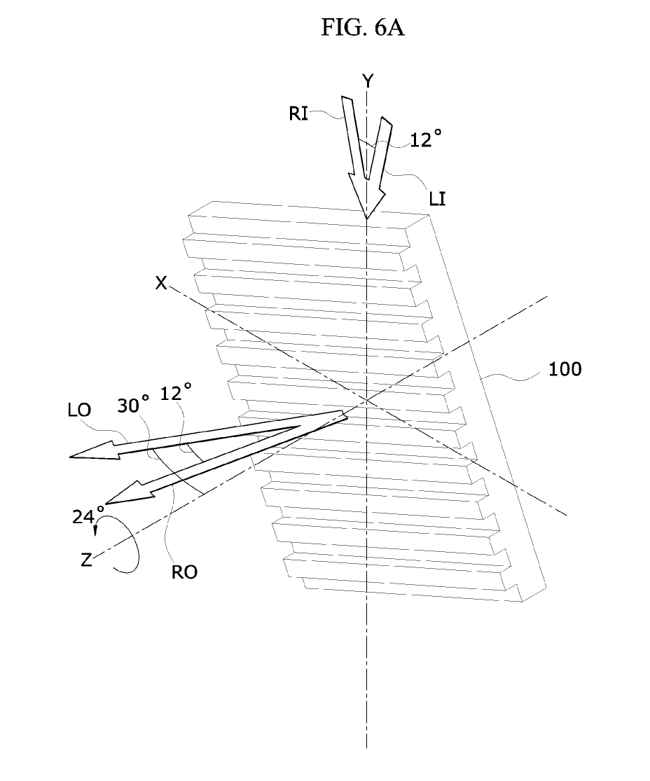

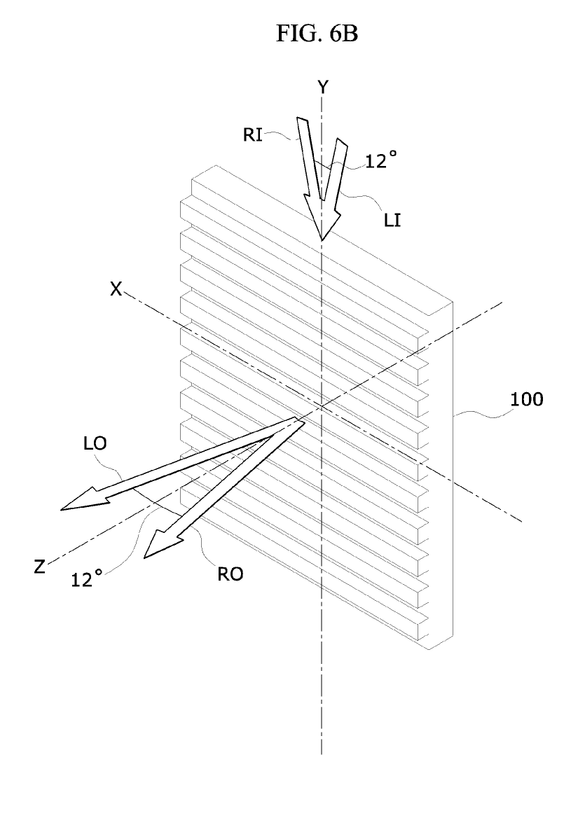

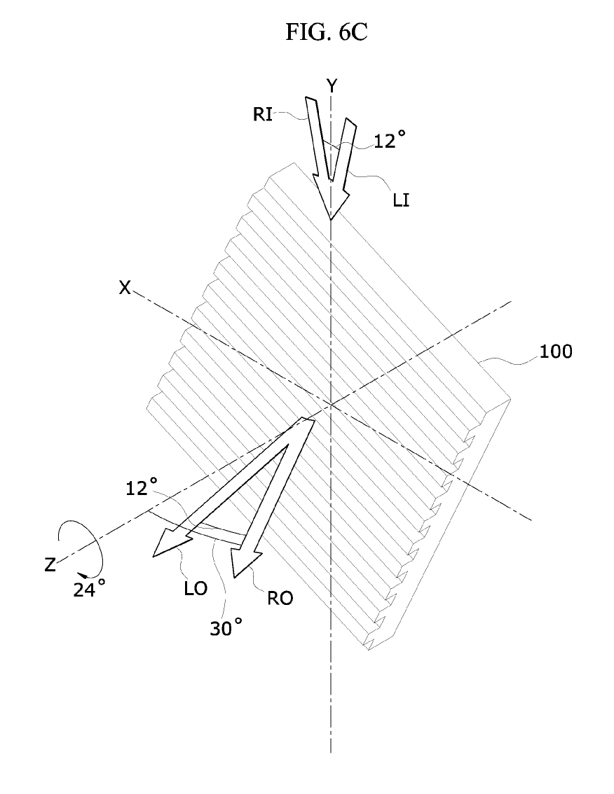

FIGS. 6A to 6C are diagrams illustrating an example where an output direction of output light is adjusted by adjusting a rotation angle of an optical waveguide in a state where an incident angle between two incident lights incident on an optical waveguide is fixed.

FIG. 6A illustrates an output direction of output light when the optical waveguide 100 is counterclockwise rotated by a certain angle, and FIG. 6B illustrates an output direction of output light when a rotation angle of the optical waveguide 100 is zero degrees. FIG. 6C illustrates an output direction of output light when the optical waveguide 100 is clockwise rotated by a certain angle.

As described above, by rotating the optical waveguide 100 in a state where an incident angle of incident light is fixed, light may be transferred to a binocular position of a viewer.

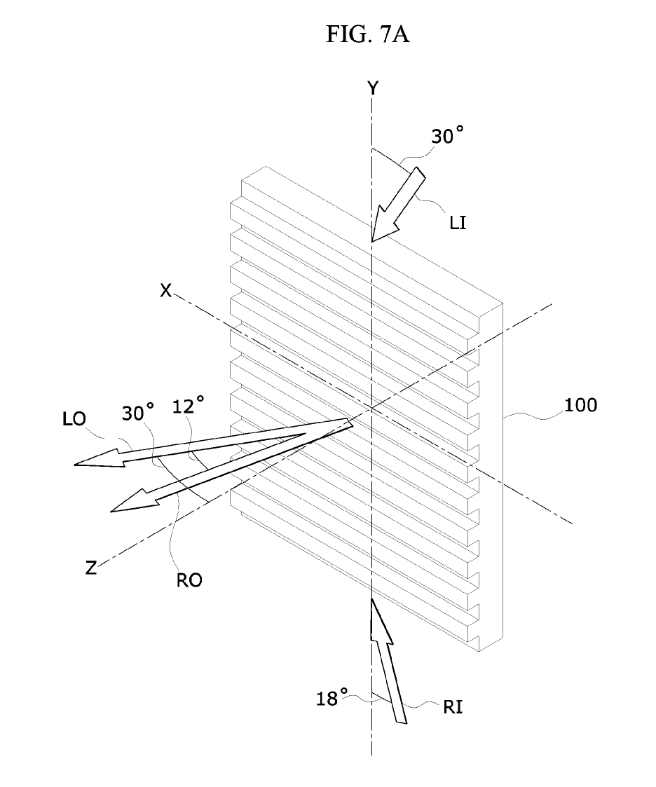

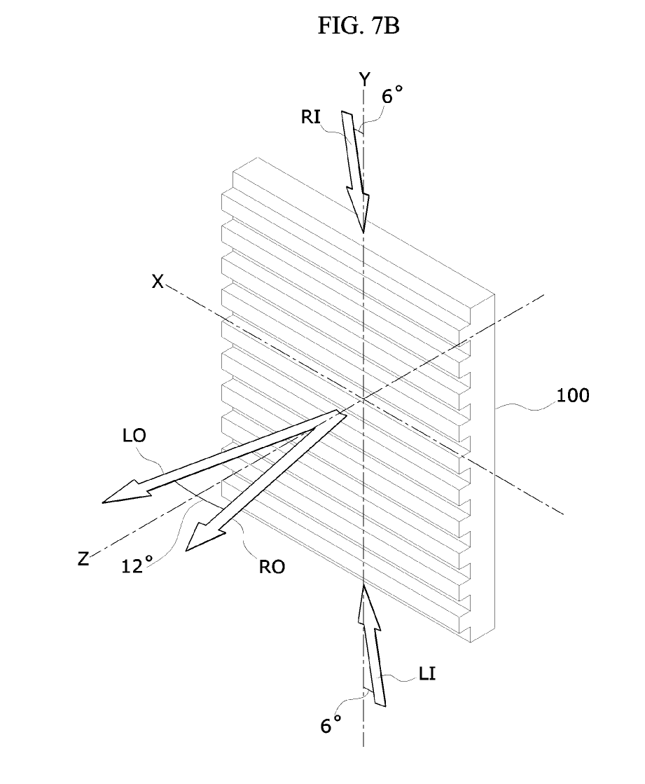

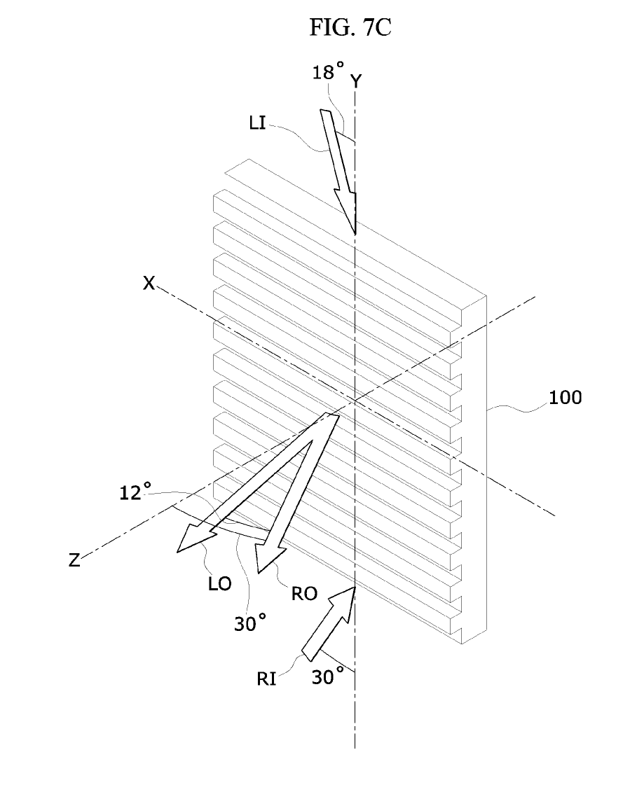

FIGS. 7A to 7C are diagrams illustrating an example where an output direction of output light is adjusted according to an incident angle between two incident lights incident on both side surfaces of an optical waveguide.

As illustrated in FIGS. 7A to 7C, an output direction of output light may be adjusted by adjusting an incident angle between two incident lights which are incident on both side surfaces of an optical waveguide.

Hereinafter, a display apparatus which includes a backlight unit including an optical waveguide and displays a 3D image will be described.

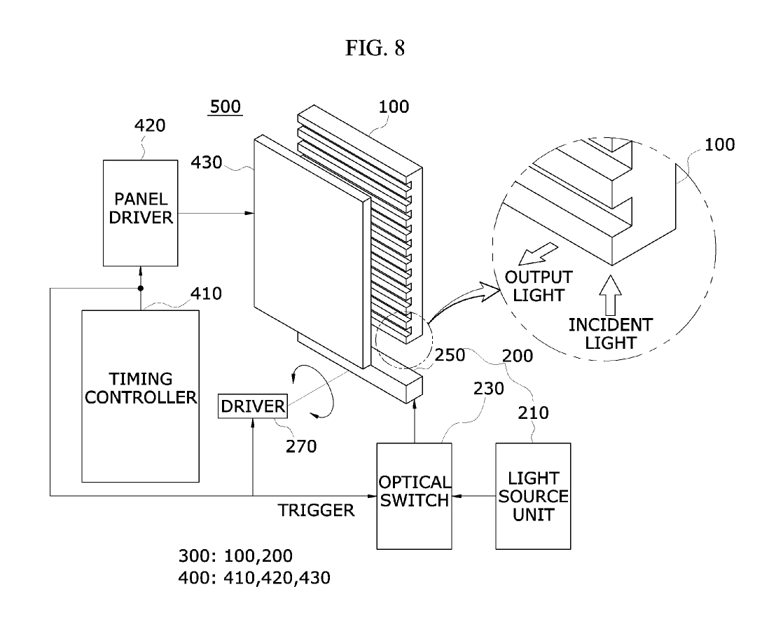

FIG. 8 is a diagram illustrating a whole configuration of a display apparatus displaying a 3D image according to an embodiment of the present invention.

Referring to FIG. 8, a display apparatus 500 according to an embodiment of the present invention may include a backlight unit 300 and a display module 400.

The backlight unit 300 may be disposed on a rear surface of a display panel included in the display module 400 and may successively output backlight to the rear surface at multi output angles. That is, the backlight output from the backlight unit 300 may be irradiated while moving the rear surface of the display panel in a horizontal direction according to the output angles. In this case, a timing when an output angle is changed from one output angle to another output angle may be synchronized with an output timing of a 3D image output by the display module 400.

To this end, the backlight unit 300 may include an optical waveguide 100 and a light source module 200 that outputs collimated light (a collimated beam or a planar beam, hereinafter referred to as incident light). The optical waveguide 100 has been described above with reference to FIGS. 4A to 7C, and thus, its detailed description is not repeated.

The light source module 200 may irradiate the incident light onto a side surface of the optical waveguide 100 at multi incident angles. In this case, a timing when an output angle is changed from one output angle to another output angle may be synchronized with an output timing of a 3D image output by the display module 400.

The light source module 200 may include a light source unit 210, an optical switch 230, a collimated light generator 250, and a driver 270.

The light source unit 210 may include a light emitting diode (LED) array, which generates LED light, or a laser generator that generates a laser beam.

The optical switch 230 may receive single source light from the light source unit 210 through a transmission means such as an optical fiber and may separate the single source light into left-eye single source light and right-eye single source light.

The collimated light generator 250 may respectively convert the left-eye single source light and right-eye single source light, obtained through separation by the optical switch 230, into left-eye incident light and right-eye incident light having a collimated light form.

The collimated light generator 250 may include elements such as a line generator lens, a cylindrical lens, and a 1×N planar lightwave circuit (PLC) splitter. Here, the 1×N PLC splitter may divide single input light into N number of lights to generate incident light having the collimated light form.

When the collimated light generator 250 includes the 1×N PLC splitter, the collimated light generator 250 may convert each of the left-eye single source light and right-eye single source light, obtained through separation by the optical switch 230, into N number of source lights to generate the N source lights as left-eye input light and right-eye input light having the collimated light form. In this case, a microlens array or a cylindrical lens may be attached to an output end of the 1×N PLC splitter so that the left-eye input light and the right-eye input light having the collimated light form are incident on the optical waveguide 100 without being spread.

The driver 270 may physically rotate the collimated light generator 250 to change an incident angle between the left-eye input light and the right-eye input light in multi directions. At this time, the driver 270 may determine a rotation timing of the collimated light generator 250 to be synchronized with an output timing of a 3D image output by the display module 400. To this end, the driver 270 may receive a synchronization signal, which controls the output timing, from the display module 400.

The driver 270 may include a step motor (not shown), which generates a rotational force for rotating the collimated light generator 250 clockwise or counterclockwise, and a rotatable connection member (not shown) that transfers the rotational force to the collimated light generator 250.

In another embodiment, the driver 270 may directly rotate the collimated light generator 250 in a horizontal direction, but a beam steering device using electro-wetting, liquid crystal, and/or the like may adjust an incident direction of input light to the horizontal direction.

Even when the beam steering device is used, the synchronization signal supplied from the display module 400 may be used for determining a rotation timing of the collimated light generator 250 to be synchronized with an output timing of a 3D image.

In all cases, a timing when an output angle of backlight (output light) output through the optical waveguide 100 may be synchronized with an output timing of a 3D image, based on a change timing of an incident angle of incident light synchronized with the output timing of the 3D image.

The inventor may define, as a time division method, a method where a timing when an output angle of backlight is synchronized with an output timing when the display module outputs a 3D image.

The display module 400 may sequentially output a 3D image, corresponding to the backlight which is applied thereto according to the time division method, in multi directions.

The display module 400 may include a timing controller 410, a panel driver 420, and a display module 430.

The timing controller 410 may generate various control signals including a synchronization signal for controlling an output timing of a 3D image in the time division method. The timing controller 410 may supply the control signals to the panel driver 420 and the driver 270 that rotates the collimated light generator.

The panel driver 420 may generate a driving signal for time-divisionally driving all pixels of the display panel 430 according to the control signal from the timing controller 410.

The display panel 430 may include a plurality of pixels which are arranged in a matrix type, and all the pixels may be time-divisionally driven by the driving signal.

The display panel 430 may receive output light which is output in multi directions from the backlight unit 300 and may successively supply a 3D image, including a left-eye image and a right-eye image which are alternately output according to the time division method, in multi directions.

As described above, the display panel may reproduce a 3D image corresponding to each viewpoint according to the time division method and may adjust an incident angle of incident light incident on the optical waveguide, thereby implementing an HPO InIm 3D image display that supplies only a horizontal parallax.

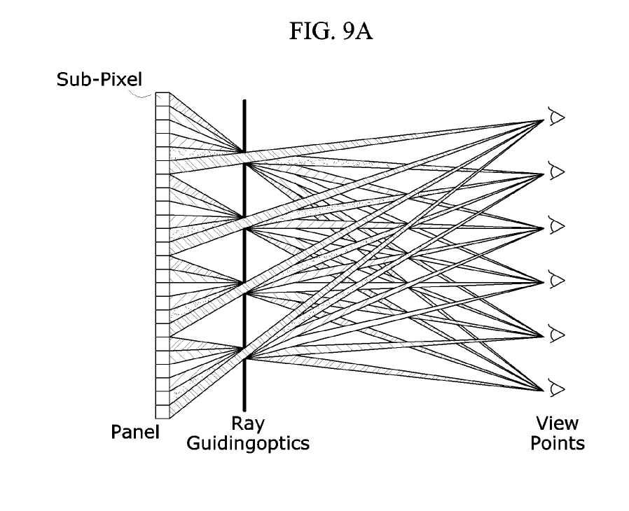

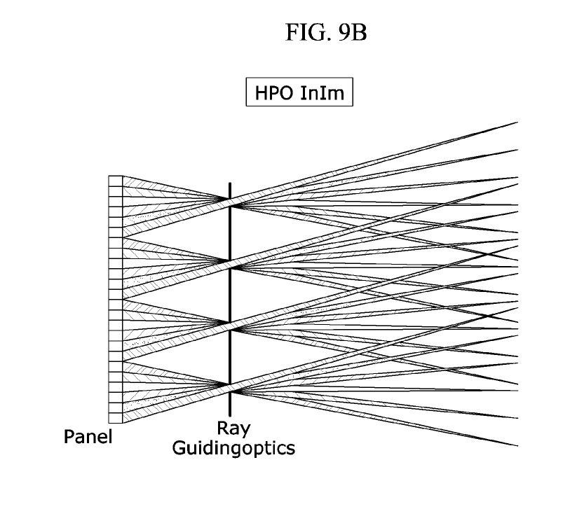

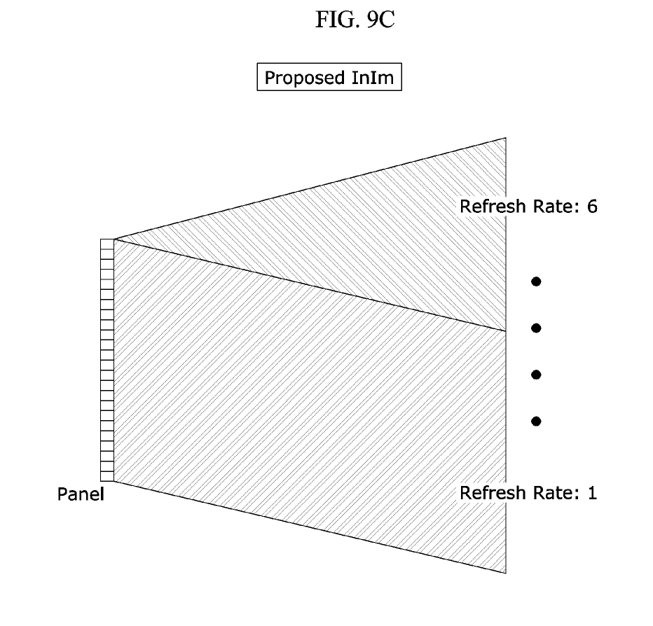

FIG. 9A is a diagram schematically illustrating a method of controlling ray output from a display panel according to a conventional multi-viewpoint-based 3D image display method. FIG. 9B is a diagram schematically illustrating a method of controlling ray output from a display panel according to a conventional HPO InIm 3D image display method. FIG. 9C is a diagram schematically illustrating a method of controlling ray output from a display panel according to an HPO InIm 3D image display method to which the present invention is applied.

As illustrated in FIGS. 9A and 9B, the conventional HPO InIm 3D image display method may control a direction of ray emitted from a display panel by using ray guiding optics such as a parallax barrier or a lenticular lens.

In conventional methods, all pixels of the display panel may be equally divided based on the number of viewpoints, and a 3D image corresponding to each of the viewpoints may be reproduced based on the number of divided pixels by viewpoint. For this reason, the conventional methods have a common drawback where a resolution of a 3D image is proportional to the number of viewpoints.

On the other hand, as illustrated in FIG. 9C, a glasses-free 3D image display method to which the present invention is applied may time-divisionally reproduce a 3D image corresponding to each of viewpoints by using all pixels, thereby reproducing a high-quality 3D image without any reduction in resolution.

Moreover, unlike a conventional multi-viewpoint-based 3D image display method illustrated in FIG. 9A which enables a user to feel a sense of three dimensions at only a fixed position, the glasses-free 3D image display method to which the present invention is applied may adjust an incident angle of incident light incident on an optical waveguide to adjust an output direction of output light (or backlight) to various directions, thereby enabling a number of users to simultaneously view a 3D image within a certain zone.

By applying this, control may be performed in order for a user to view a 3D image within a certain zone, and control may be performed in order for another user, located in another zone, to view only a two-dimensionally (2D) image. Such a control method is suitable for using a security/privacy function.

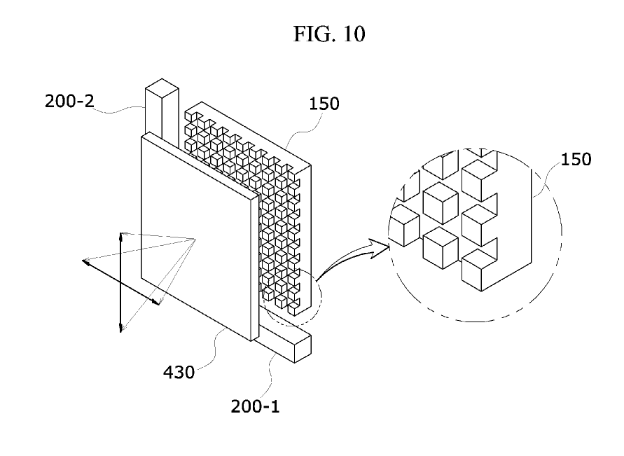

FIG. 10 is a diagram illustrating a whole configuration of a display apparatus displaying a 3D image according to another embodiment of the present invention.

Referring to FIG. 10, unlike the display apparatus of FIG. 8 which reproduces a 3D image according to backlight adjusted in a horizontal direction, the display apparatus according to another embodiment of the present invention may reproduce a 3D image by using backlight capable of being adjusted in a vertical direction as well as the horizontal direction.

To this end, the display apparatus according to another embodiment of the present invention may include an optical waveguide 150 having a 2D grating pattern, a first light source module 200-1 that irradiates first source light, having an incident angle which is adjusted, onto one side surface of the optical waveguide 150, and a second light source module 200-2 that irradiates second source light, having an incident angle which is adjusted, onto the other side surface adjacent to the one side surface.

The 2D grating pattern of the optical waveguide 150 may include a plurality of projection patterns which are arranged in a matrix type, unlike the projection patterns of FIG. 4A which extend in one direction at certain intervals.

The first light source module 200-1 may have the same configuration and function as those of the light source module 200 illustrated in FIG. 8, and thus, the description of the light source module 200 may be applied to the first light source module 200-1.

The second light source module 200-2 may have the same configuration and function as those of the first light source module 200-1, and may have a difference with the first light source module 200-1 in that the second light source module 200-2 irradiates output light (backlight), which is adjusted in a vertical direction D2 instead of a horizontal direction D1, onto a display panel 430. Therefore, the description of the first light source module 200-1 may be applied to the second light source module 200-2.

As described above, since the display apparatus according to another embodiment of the present invention includes the optical waveguide 150 having the 2D grating pattern and two the light source modules 200-1 and 200-2, backlight may be adjusted in the vertical direction D2 as well as the horizontal direction D1. This denotes that a high-quality 3D image is provided to a plurality of viewers which are located in a vertical direction.

Conventional directional backlight technologies correspond to a system in which rays are concentrated on a specific fixed position or which tracks a position of eyes to move a position on which rays are concentrated.

However, such conventional methods have a limitation where a position which enables a user to feel a sense of three dimensions is fixed, or an additional device such as a viewpoint tracking device is added.

On the other hand, according to the embodiments of the present invention, since the integral imaging system that provides only a horizontal parallax is implemented in the time division method, successive 3D images are simultaneously provided to a plurality of persons in a certain zone without using an additional device.

Moreover, a 3D image is limited to within a certain zone, and a 2D image is reproduced in a zone other than the certain zone. Accordingly, a privacy mode which enables a user to view a 3D image in only a certain zone is realized.

Moreover, in conventional methods for implementing a glasses-free 3D display system, a parallax barrier or a liquid crystal display (LCD) or a lenticular lens which performs a function of the parallax barrier is attached to a display panel. For this structural reason, the conventional methods have a common limitation where a resolution of a reproduced 3D image is reduced in inverse proportion to the number of viewpoints.

On the other hand, since the 3D image display technology according to the embodiments of the present invention realizes a directional backlight function by using a thin-plate optical waveguide having a grating pattern, the display apparatus is manufactured in a thin and simple structure. Also, since an image is reproduced by using all pixels of a display panel, a high-quality 3D image is provided without any reduction in resolution.

According to the embodiments of the present invention, since the integral imaging system that provides only a horizontal parallax is implemented in the time division method, successive 3D images are simultaneously provided to a plurality of persons in a certain zone without using an additional device.

Moreover, an output direction of a 3D image is freely controlled, and thus, the privacy mode where a user is capable of viewing a 3D image at only a specific position is realized.

Moreover, since a 3D image is reproduced by using all pixels of a display panel, the reproduced 3D image has very high quality without any reduction in resolution.

Moreover, in addition to a 3D image, a normal 2D image is reproduced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A backlight unit for outputting backlight used to reproduce a three-dimensional (3D) image, the backlight unit comprising:
a light source module configured to output collimated light whose an incident angle is adjusted; and
an optical waveguide including a side surface receiving the collimated light and a top outputting backlight corresponding to the collimated light, wherein the optical waveguide outputs, through a whole portion of the top, the backlight whose an output angle is adjusted according to the incident angle.

2. The backlight unit of claim 1, wherein the light source module comprises:
a light source unit configured to generate single source light;
an optical switch configured to separate the single source light into left-eye single source light and right-eye single source light;
a collimated light generator configured to divide each of the left-eye single source light and the right-eye single source light into N (where N is a natural number equal to or more than two) number of source lights to generate the collimated light that includes left-eye collimated light corresponding to the left-eye single source light and right-eye collimated light corresponding to the right-eye single source light; and
a driver configured to rotate the collimated light generator to adjust an incident angle of the collimated light.

3. The backlight unit of claim 2, wherein the collimated light generator comprises a 1×N planar lightwave circuit (PLC) splitter configured to divide each of the left-eye single source light and the right-eye single source light into N (where N is a natural number equal to or more than two) number of source lights to simultaneously output the N source lights.

4. The backlight unit of claim 2, wherein the collimated light generator alternately irradiates the left-eye collimated light and the right-eye collimated light onto a side surface of the optical waveguide according to a time division method.

5. The backlight unit of claim 4, wherein the collimated light generator alternately irradiates the left-eye collimated light and the right-eye collimated light onto the side surface of the optical waveguide according to the time division method.

6. The backlight unit of claim 1, wherein
the optical waveguide comprises a plurality of projection patterns continuously arranged on the top at certain intervals to have a certain length, and
incident light which is incident through the side surface is diffracted by the plurality of projection patterns, and the backlight is thereby output through the whole portion of the top.

7. A display apparatus for reproducing a three-dimensional (3D) image, the display apparatus comprising:
a backlight unit configured to successively output backlight at multi output angles; and
a display module configured to successively output a 3D image corresponding to the backlight in multi output directions respectively corresponding to the multi output angles.

8. The display apparatus of claim 7, wherein the backlight unit changes an output angle of the backlight according to an output timing of the 3D image output by the display module.

9. The display apparatus of claim 8, wherein the backlight unit receives a synchronization signal, which controls the output timing of the 3D image, from the display module and changes the output angle of the backlight in response to the synchronization signal.

10. The display apparatus of claim 7, wherein the display module comprises:
a timing controller configured to generate a synchronization signal for controlling the output timing of the 3D image;
a panel driver configured to a driving signal according to the synchronization signal; and
a display panel configured to successively output the 3D image corresponding to the backlight in multi output directions respectively corresponding to the multi output angles according to the driving signal.

11. The display apparatus of claim 10, wherein the backlight unit comprises:
a light source module configured to output collimated light which is sequentially changed at multi incident angles according to a timing synchronized with the synchronization signal; and
an optical waveguide including a side surface receiving the collimated light and a top outputting backlight corresponding to the collimated light, wherein the optical waveguide outputs, through a whole portion of the top, the backlight at multi output angles respectively corresponding to the multi incident angles.

12. The display apparatus of claim 11, wherein the light source module comprises:
a light source unit configured to generate single source light;
an optical switch configured to separate the single source light into left-eye single source light and right-eye single source light;
a collimated light generator configured to divide each of the left-eye single source light and the right-eye single source light into N (where N is a natural number equal to or more than two) number of source lights to generate the collimated light that includes left-eye collimated light corresponding to the left-eye single source light and right-eye collimated light corresponding to the right-eye single source light; and
a driver configured to rotate the collimated light generator to adjust an incident angle of the collimated light at the timing synchronized with the synchronization signal.

13. The display apparatus of claim 11, wherein
the optical waveguide comprises a plurality of projection patterns continuously arranged on the top at certain intervals to have a certain length, and
incident light which is incident through the side surface is diffracted by the plurality of projection patterns, and the backlight is thereby output through the whole portion of the top.
